(19) United States
(12) Patent Application Publication
(10) Pub. No.: US 2020/0186434 A1
(43) Pub. Date: Jun. 11, 2020

(54) TRAINING SYSTEM SERVER ARCHITECTURE, VIDEO DATA TRANSMISSION METHOD THEREOF, AND COMPUTER STORAGE MEDIUM

(71) Applicant: PING AN TECHNOLOGY (SHENZHEN) CO., LTD., Shenzhen, Guangdong (CN)

(72) Inventor: Bingrui Zhang, Shenzhen, Guangdong (CN)

(21) Appl. No.: 16/632,881

(22) PCT Filed: May 31, 2018
(86) PCT No.: PCT/CN2018/089199

§ 371 Date: Jan. 22, 2020

(30) Foreign Application Priority Data
Nov. 15, 2017 (CN) 201711130623.0

(51) Int. Cl. H04L 12/24; G06K 9/62; H04N 21/24

(52) U.S. Cl. CPC H04L 41/16; H04L 41/0896; H04N 21/2402; G06K 9/6256; H04L 41/0813

(57) ABSTRACT

The present disclosure publishes a training system server architecture and a video transmission method according to the above architecture, the architecture includes a control center for pushing a node control table; a management gateway connected to the control center and configured to generate a forward logic and allocate network bandwidth according to the node control table; a core node, coupled to the management gateway and configured to receive the forward logic and training data transmitted by a video server, and forward the training data according to the forward logic to a trained terminal; secondary nodes, coupled to the core node and configured to receive the forward logic and the training data, forward the training data to the trained terminal according to the forward logic, and store the training data in a storage set in the secondary node. Thus, an efficiency of a network training is improved.

### CROSS-REFERENCE TO RELATED APPLICATION

The present application claims priority to Chinese Patent Application No. 201711130623.0 entitled “TRAINING SYSTEM SERVER ARCHITECTURE, VIDEO DATA TRANSMISSION METHOD THEREOF, AND COMPUTER STORAGE MEDIUM” filed on Nov. 15, 2017, the contents of which is expressly incorporated by reference herein in its entirety.

### TECHNICAL FIELD

The present disclosure relates the field of servers, and specially relates to a training system server architecture, a video data transmission method thereof, and a computer storage medium.

### BACKGROUND

On Jul. 4, 2015, the State Council issues the State Council's guiding options of actively promoting “Internet +”. “Internet +” is a new format of Internet development under innovation 2.0, and “Internet +” is a new format of Internet development under innovation 2.0, and is an Internet format evolution pushing by social knowledge innovation 2.0 and a new format of social economy development of birthing thereof. By the development of “Internet +” in full swing, it is served as a new format, and it achieves a combination of the Internet and tradition industry based on Internet information technology, for optimizing production factors, updating business system, and reconstructing business modes, and so on.

Education based on the “Internet +” is also vigorously developing with the technological progress.

At present, there are a plurality of formats of network training based on the Internet, which includes asynchronous on-demand learning, live broadcast learning, implement interactive learning, and so on.

It is well-known that the network training has the characteristics of wide distribution, long distance, less special class, hard opening of classes, less students, hard opening of classes, less instructors, and weak skill. The quality of the network training can be improved by setting a High-Definition video teaching system and supporting running of the network training and resources of instructors.

The network training usually uses F5 load balancing server architecture. However, the network training based on High-Definition video has a feature of large traffic. The F5 load balancing server architecture is not satisfied for transmitting the large traffic video.

As recited above, in order to cater to the call of “Internet +” and improve the disadvantages of the network training in the prior art, it is necessary to provide a new training system server architecture and a video transmission method thereof.

### SUMMARY OF THE INVENTION

The present disclosure involves a training system server architecture, a video data transmission method thereof, and a computer storage medium, aiming to improve a quality of the video and an efficiency of the network training while transmitting in a large range and a long distance.

To achieve the aim, the present disclosure provides a training system server architecture. The training system server architecture includes:

a control center, configured to push a node control table;

a management gateway, coupled to the control center, and configured to generate a forward logic and allocate network bandwidth according to the node control table;

a core node, coupled to the management gateway, and configured to receive the forward logic and training data transmitted by a video server and forward the training data according to the forward logic; and

secondary nodes, coupled to the core node, and configured to receive the forward logic and the training data, transmit the training data according to the forward logic to a trained terminal, and store the training data on a storage of the secondary nodes.

To achieve the aim, the present disclosure provides a video data transmission method, used in a training system server architecture; the training system server architecture includes a control center, a management gateway, a core node, secondary nodes, a video server, and trained terminals. The method includes the following steps.

The control center pushing a node control table;

The management gateway generating a forward logic of audio and video data according to the node control table and allocating network bandwidth;

The core node receiving training data transmitted by a video server, and selecting a node for forwarding the training data according to the forward logic;

The secondary nodes receiving the training data transmitted by the core node, and multicasting the training data to the trained terminal according to the forward logic.

To achieve the aim, the present disclosure provides a computer readable storage medium. The computer readable storage medium stores video data transmitting programs. The video data transmitting programs are executed by at least one processor, thus the at least one processor performs steps of a video data transmission method.

The present disclosure provides a training system server architecture with a multiple layers cascade manner. A tree structure is formed by a control center, a management gateway, a core node, second nodes, and training terminals. An objective for improving a transmission quality and a network training efficiency in a large range and in a long distance is achieved by selecting a node for forwarding video data and controlling network bandwidth through the control center and management gateway.

### BRIEF DESCRIPTION OF THE FIGURES

Implementations of the present disclosure will now be described, by way of example only, with reference to the attached figures, wherein:

FIG. 1 is a diagram view of a first embodiment of a training system server architecture.

FIG. 2 is diagram view of a second embodiment of a training system server architecture.

FIG. 3 is a diagram view of a third embodiment of a training system server architecture.

FIG. 4 is a flowchart of a fourth embodiment of a video transmission method.

FIG. 5 is a flowchart of a fifth embodiment of a video transmission method.

FIG. 6 is a flowchart of a sixth embodiment of a video transmission method.

### DETAILED DESCRIPTION

In order to making the technical problems, the technical solutions, and beneficial effects to be clearer and more understand, the present disclosure is further described in detail with reference to the accompanying drawings and the embodiments. It will be understood that the specific embodiments described herein are merely used for describing the present disclosure, but are not intended to limit the present disclosure.

It needs to be explained that the descriptions related to “first”, “second” and so on in the present disclosure are only description purpose, but are not being understood as indicating or implying a relative significance of itself or implying an amount of the indicated technical feature. Thus, the features limited with “first” or “second” are indicated or implied including at least one feature. Besides, the technical solutions between different embodiments can be mutual combination, but only based on being achieved by those of an ordinary skill in the art, it should be recognized that the technical solution is not existed when the combination of the technical solutions being mutual contradiction or being unable to be achieved, and it is also not within the protecting range of the present disclosure.

### First Embodiment

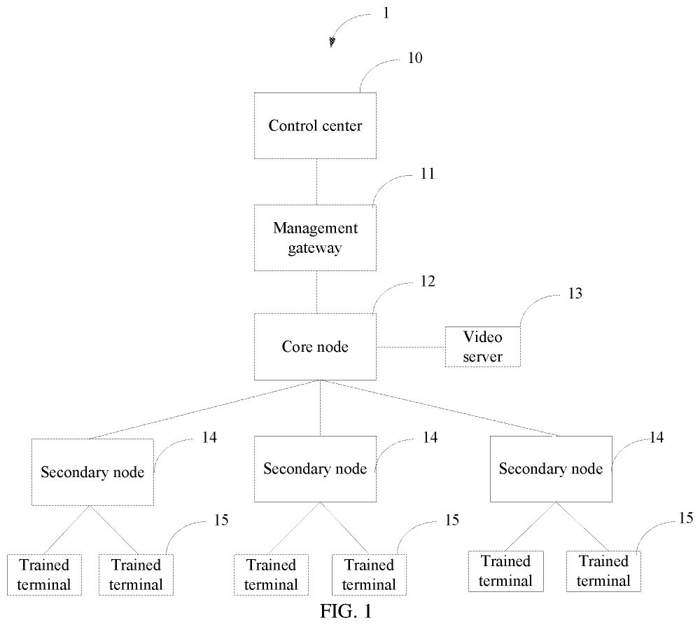

As shown in FIG. 1, a schematic diagram of a training system server architecture 1 is provided by the first embodiment of the present disclosure.

As shown in FIG. 1, in the embodiment, the training system server architecture 1 is provided by the present disclosure. The training system server architecture 1 includes a control center 10, a management gateway 11, a core node 12, a video server 13, secondary nodes 14, and trained terminals 15. The control center 10, the management gateway 11, the core node 12, the secondary nodes 13, and the trained terminals 15 are orderly connected, the video server 13 is connected to the core node 12.

In one embodiment, the control center 10 is used for pushing a node control table.

In detail, the control center 10 generates the node control table according to an amount and addresses of the trained terminals 15. There are a node data table and a bandwidth allocating table in the node control table. The amount and the addresses of the trained terminals 15 are updated through a network in a real time. The control center 10 generates the node control table according to the above information. The node data table in there is used for selecting a node for transmitting data, and a network bandwidth is allocated according to the bandwidth allocating table.

In one embodiment, the management gateway 11 is used for generating a forward logic and allocating the network bandwidth according to the node control table.

In detail, the management gateway 11 uniformly manages the forward logic of audio and video data and allocates the network bandwidth. For example, when the network training locations are distributed in different provinces, cities, or districts, different training are selected by different locations because of different requirements, thus there is a difference of trained terminals 15 joined the training at each time. Different forward logic according to the difference can be set according to the time, for improving the network bandwidth using, and the training efficiency.

In one embodiment, the core node 12 is used for receiving the forward logic and the training data transmitted by the video server 13, and forwarding the training data according to the forward logic.

In detail, the core node 12 is used for processing the training data transmitted by the video server 13, the training data can be audio and video data, the core node 12 is used for accomplishing a routing, a forwarding, and a processing of the audio and video data.

In detail, the core node 12 receives the forward logic and selects a secondary node 14 according to the forward logic. For example, the secondary nodes 14 are set as region push nodes in different regions, when selecting a specific secondary node in the forward logic for transmitting the training data, the core node 12 pushes the training data to the specific secondary node.

In detail, when there are multiple trained terminals, there are also multiple secondary nodes 14. For example, the secondary nodes 14 are set at each province, the secondary nodes 14 transmits the training data to the trained terminals 15 in different provinces.

In detail, there are multiple trained terminals 15, including, but not limiting, mobile terminals (such as a smart phone), and also including classroom trained terminals.

### Second Embodiment

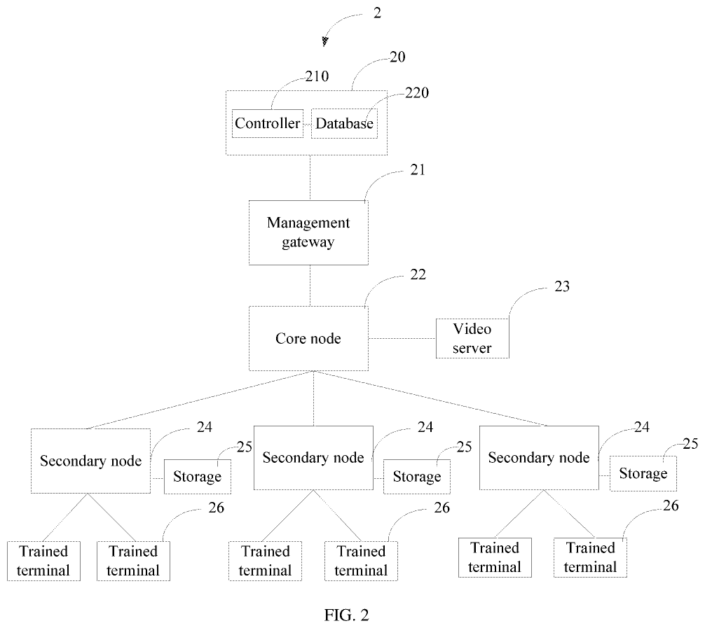

As shown in FIG. 2, a schematic diagram of a training system server architecture 2 is provided by the second embodiment of the present disclosure.

As shown in FIG. 2, in one embodiment, the present disclosure provides the training system server architecture 2. The training system server architecture 2 includes a control center 20, a management gateway 21, a core node 22, a video server 23, secondary nodes 24, a storage 25, and trained terminals 26. The control center 20, the management gateway 21, the core node 22, the secondary nodes 24, and trained terminals 26 are orderly connected, the video server 23 is connected to the core node 22, the storage 25 is connected to the secondary nodes 24.

In one embodiment, the control center 20 is used for pushing a node control table.

In detail, the control center 20 includes a central controller 210 and a database 220. The central controller 210 calls data in the database 220 to generate a node control table. There are a node data table and a bandwidth allocating table in the node control table. There are location information, IP addresses of the trained terminals 26, an amount of the trained terminals 26, training requirements, and so on in the database 220. The information in the database 220 are updated through a network in a real time. The central controller 210 generates the node control table according to the information in the database 220. The node control table is used for selecting a node for transmitting data and allocating network bandwidth according to the bandwidth allocating table.

In one embodiment, the management gateway 21 is used for generating a forward logic and allocating the network bandwidth according to the node control table.

In detail, the management gateway 21 uniformly manages the forward logic of audio and video data and allocates the network bandwidth. For example, when the network training locations are distributed in different provinces, cities, or districts, different training are selected by different locations because of different requirements, thus there is a difference of trained terminals 26 joined the training at each time. Different forward logic according to the difference can be set according to the time, the network bandwidth is better used, and the training is more efficiency.

In one embodiment, the core node 22 is used for receiving the forward logic and the training data transmitted by the video server 23 and forwarding the training data according to the forward logic.

In detail, the core node 22 is used for processing the training data transmitted by the video server 23, the training data can be audio and video data, the core node 22 is used for accomplishing routing, forwarding, and processing of the audio and video data.

In detail, the core node 22 receives the forward logic and selects a secondary node 24 according to the forward logic. For example, the secondary nodes 24 are set as region push nodes of different regions, when selecting a specific secondary node in the forward logic for transmitting the training data, the core node 22 pushes the training data to the specific secondary node.

In one embodiment, the secondary node 24 is used for receiving the forward logic and the training data, transmitting the training data to the trained terminal 26 according to the forward logic, and storing the training data in the storage 25 of the secondary node 24. The advantage of storing the training data on the storage 25 is that the trained terminal 26 can demand or download the trained audio and video on the storage 25, it is contributed to improve the training effect. The network training can be a live training in real time, also can be a self-learn according to an on-demand manner, it is a meaningful to the trainee by setting a storage 25. Certainly, in other embodiments, there is a storage 25 in the core node 22.

In detail, the storage 25 can be a non-volatile storage, such as a ROM, a EPROM, or a Flash Memory, and so on.

In detail, when there are multiple trained terminals, there are also multiple secondary nodes 24. For example, the secondary nodes 24 are set at each province, the secondary nodes 24 transmits the training data to the trained terminals 26 in different provinces.

In detail, there are multiple trained terminals 15, which includes, but not limiting, mobile terminals (such as smart phones), and also includes classroom trained terminals.

### Third Embodiment

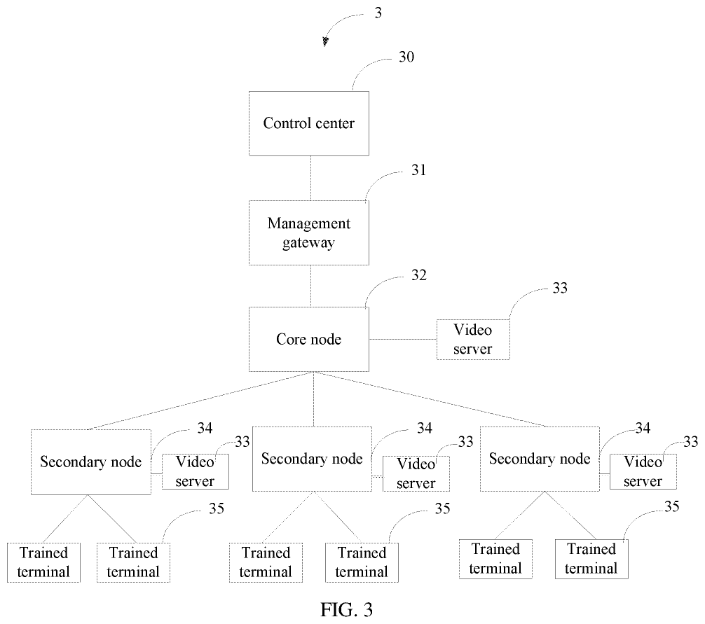

As shown in FIG. 3, a schematic diagram of a training system server architecture 3 is provided by the third embodiment of the present disclosure.

As shown in FIG. 3, in one embodiment, the present disclosure provides the training system server architecture 3. The training system server architecture 3 includes a control center 30, a management gateway 31, a core node 32, a video server 33, secondary nodes 34, and trained terminals 35. The control center 30, the management gateway 31, the core node 32, the secondary nodes 34, and trained terminals 35 are orderly connected, the video server 33 is connected to the core node 32 and the secondary nodes 34.

In one embodiment, the control center 30 is used for pushing a node control table.

In detail, the control center 30 generates the node control table according to an amount and addresses of the trained terminals 35. There are a node data table and a bandwidth allocating table in the node control table. The amount and the addresses of the trained terminals 35 are updated through a network in a real time. The control center 30 generates the node control table according to the above information. The node data table in there is used for selecting a node for transmitting data, a network bandwidth is allocated according to the bandwidth allocating table.

In one embodiment, the management gateway 31 is used for generating a forward logic and allocating the network bandwidth according to the node control table.

In detail, the management gateway 31 uniformly manages the forward logic of audio and video data and allocates the network bandwidth. For example, when the network training locations are distributed in different provinces, cities, or districts, different training are selected by different locations because of different requirements, thus there is a difference of trained terminals 35 joined the training at each time. Different forward logic according to the difference can be set according to the time, the network bandwidth is better used, and the training is more efficiency.

In one embodiment, the core node 32 is used for receiving the forward logic and the training data transmitted by the video server 33, and forwarding the training data according to the forward logic.

In detail, the core node 32 can include a multi-control unit (MCU) for processing the training data transmitted by the video server 33, the training data can be audio and video data, the MCU is used for accomplishing routing, forwarding, and processing of the audio and video data. For example, after synchronous separating information flow of the training data, the MCU extracts information of audio, video, data, signaling, and so on, transmits the information to the information process module, and accomplishes a process of the information, such as audio mixing or switching, video information mixing or switching, data information broadcasting and routing, time setting, signaling controlling, and so on. At last, the processed audio, video, data, and signaling are re-combined together to be transmitted to each corresponding node.

In detail, the core node 32 receives the forward logic and selects a secondary node 34 according to the forward logic. For example, the secondary nodes 34 are set as region push nodes of different regions, when selecting a specific secondary node in the forward logic for transmitting the training data, the core node 32 pushes the training data to the specific secondary node.

In one embodiment, the secondary node 34 is used for receiving the forward logic and the training data, and transmitting the training data to the trained terminal 35 according to the forward logic.

In detail, the secondary node 34 can be a MCU, when there are multiple trained regions, there are also multiple secondary nodes 34.

In detail, when there are multiple trained terminals distributed in different regions. The trained terminal 35 can be a mobile terminal (such as a smart phone), a personal computer, and also can include a classroom trained terminal.

In detail, the secondary node 34 also can set a video server 33, when the region corresponding to the secondary node 34 with a requirement of training the trained terminals 35 alone, it can be trained alone.

### Fourth Embodiment

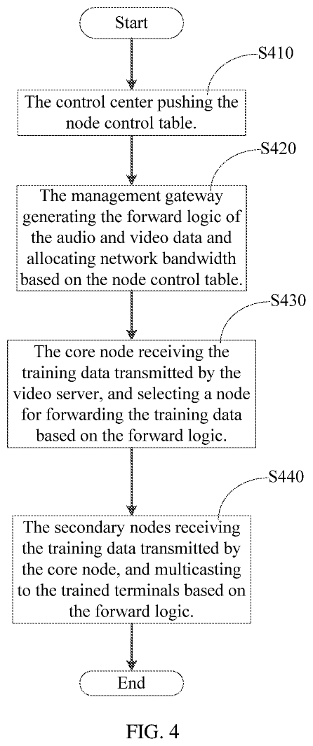

As shown in FIG. 4, a flowchart of a video transmission method, used in the above recited training system server architecture is provided by the fourth embodiment of the present disclosure, the method includes the follow steps (please referring to FIG. 3 together):

S410, the control center 30 pushing the node control table.

In detail, the control center 30 pushes the node control table, there are a node data table and a bandwidth allocating table in the node control table. The node data table in there is used for selecting a node for transmitting data, and a network bandwidth is allocated according to the bandwidth allocating table.

S420, the management gateway 31 generating a forward logic and allocating the network bandwidth according to the node control table.

In detail, the management gateway 31 uniformly manages the forward logic of audio and video data and allocates the network bandwidth. For example, when the network training locations are distributed in different provinces, cities, or districts, different training are selected by different locations because of different requirements, thus there is a difference of trained terminals 35 joined the training at each time. Different forward logic according to the difference can be set according to the time, the network bandwidth is better used, and the training is more efficiency. The forward logic is a formulated forward path of the audio and video data, a bandwidth allocating plan, and a traffic allocating plan, according to the difference.

S430, the core node 32 receiving the training data transmitted by the video server 33, and forwarding the training data according to the forward logic.

In detail, the core node 32 can be a multi-control unit (MCU) for processing the training data transmitted by the video server 33, the training data can be audio and video data, the MCU is used for accomplishing a routing, a forwarding, and a processing of the audio and video data. For example, after synchronous separating information flow of the training data, the MCU extracts information of audio, video, data, signaling, and so on, transmits the information to the information process module, and accomplishes a process of the information, such as audio mixing or switching, video information mixing or switching, data information broadcasting and routing, time setting, signaling controlling, and so on. At last, the processed audio, video, data, and signaling are re-combined together to be transmitted to each corresponding node.

In detail, the core node 32 receives the forward logic and selects a secondary node 34 according to the forward logic. For example, the secondary nodes 34 are set as region push nodes of different regions, when selecting a specific secondary node in the forward logic for transmitting the training data, the core node 32 pushes the training data to the specific secondary node.

S440, the secondary nodes 34 receiving the forward logic and the training data, and transmitting the training data to the trained terminal 35 according to the forward logic.

In detail, the secondary node 34 can be a MCU, when there are are multiple trained regions, there are also multiple secondary nodes 34.

In detail, when there are multiple trained terminals distributed in different regions. The trained terminal 35 can be a mobile terminal (such as a smart phone), a personal computer, and also can include a classroom trained terminal.

### Fifth Embodiment

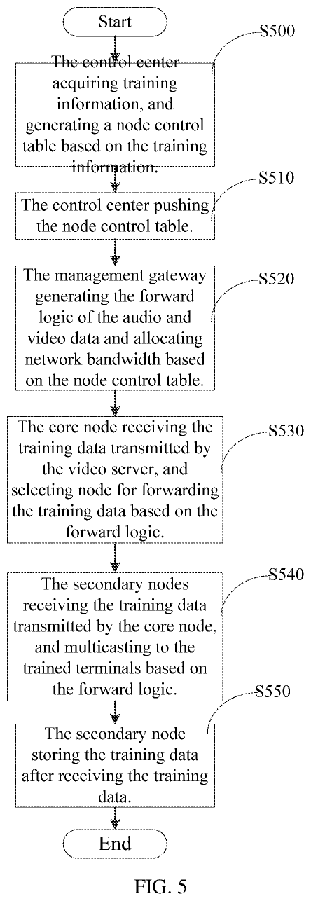

As shown in FIG. 5, a flowchart of a video transmission method, used in a above recited training system server architecture is provided by the fifth embodiment of the present disclosure, the method includes the follow steps (please referring to FIG. 3 together):

S500, the control center 30 acquiring the training information and generating a node control table according to the training information.

In detail, the control center 30 generates the node control table according to an amount and addresses of the trained terminals 35, there are a node data table and a bandwidth allocating table in the node control table. The amount and the addresses of the trained terminals 35 are updated through a network in a real time, the control center 30 generates the node control table according to the above information, the node data table in there is used for selecting a node for transmitting data, and a network bandwidth is allocated according to the bandwidth allocating table.

S510, the control center 30 pushing the node control table.

In detail, the control center 30 pushes the node control table, there are a node data table and a bandwidth allocating table in the node control table. The node data table in there is used for selecting a node for transmitting data, and a network bandwidth is allocated according to the bandwidth allocating table.

S520, the management gateway 31 generates a forward logic and allocating the network bandwidth according to the node control table.

In detail, the management gateway 31 uniformly manages the forward logic of audio and video data and allocates the network bandwidth. For example, when the network training locations are distributed in different provinces, cities, or districts, different training are selected by different locations because of different requirements, thus there is a difference of trained terminals 35 joined the training at each time. Different forward logic according to the difference can be set according to the time, the network bandwidth is better used, and the training is more efficiency. The forward logic is a formulated forward path of the audio and video data, a bandwidth allocating plan, and a traffic allocating plan, according to the difference.

S530, the core node 32 receiving the training data transmitted by the video server 33, and forwarding the training data according to the forward logic.

In detail, the core node 32 can be a multi-control unit (MCU) for processing the training data transmitted by the video server 33, the training data can be audio and video data, the MCU is used for accomplishing a routing, a forwarding, and a processing of the audio and video data. For example, after synchronous separating information flow of the training data, the MCU extracts information of audio, video, data, signaling, and so on, transmits the information to the information process module, and accomplishes a process of the information, such as audio mixing or switching, video information mixing or switching, data information broadcasting and routing, time setting, signaling controlling, and so on. At last, the processed audio, video, data, and signaling are re-combined together to be transmitted to each corresponding node.

In detail, the core node 32 receives the forward logic and selects a secondary node 34 according to the forward logic. For example, the secondary nodes 34 are set as region push nodes of different regions, when selecting a specific secondary node in the forward logic for transmitting the training data, the core node 32 pushes the training data to the specific secondary node.

S540, the secondary nodes 34 receiving the forward logic and the training data, and transmitting the training data to the trained terminal 35 according to the forward logic.

In detail, the secondary nodes 34 can be a MCU, when there are multiple trained regions, there are also multiple secondary nodes 34.

In detail, when there are multiple trained terminals distributed in different regions. The trained terminal 35 can be a mobile terminal (such as a smart phone), a personal computer, and also can include a classroom trained terminal.

S550, the secondary nodes 34 storing the training data after receiving the training data.

In one embodiment, the secondary nodes 34 are used for receiving the forward logic and the training data, transmitting the training data to the trained terminal 35 according to the forward logic, and storing the training data in the storage of the secondary nodes 34 (not shown in FIG. 3). The advantage of storing the training data on the storage is that the trained terminal 35 can demand or download the trained audio and video on the storage, it is contributed to improve the training effect. The network training can be a live training in real time, also can be a self-learn according to an on-demand manner, it is a meaningful to the trainee by setting a storage. Certainly, in other embodiments, there is storage in the core node 32.

### Sixth Embodiment

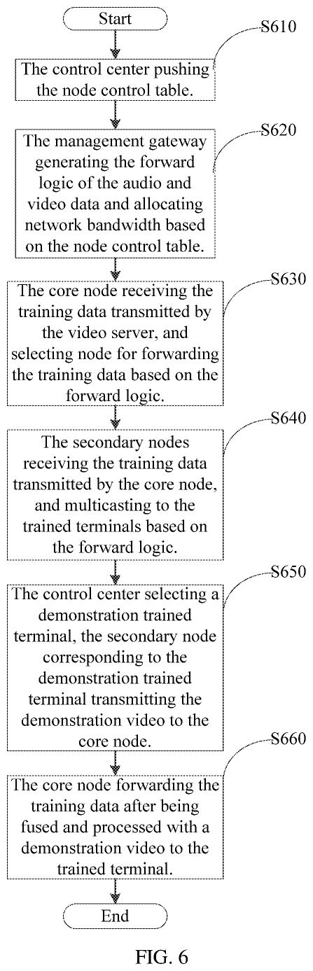

As shown in FIG. 6, a flowchart of a video transmission method, used in a above recited training system server architecture is provided by the sixth embodiment of the present disclosure, the method includes the follow steps (please referring to FIG. 3 together):

S610, the control center 30 pushing the node control table.

In detail, the control center 30 pushes the node control table, there are a node data table and a bandwidth allocating table in the node control table. The node data table in there is used for selecting a node for transmitting data, and a network bandwidth is allocated according to the bandwidth allocating table.

S620, the management gateway 31 generating a forward logic and allocating the network bandwidth according to the node control table.

In detail, the management gateway 31 uniformly manages the forward logic of audio and video data and allocates the network bandwidth. For example, when the network training locations are distributed in different provinces, cities, or districts, different training are selected by different locations because of different requirements, thus there is a difference of trained terminals 35 joined the training at each time. Different forward logic according to the difference can be set according to the time, the network bandwidth is better used, and the training is more efficiency. The forward logic is a formulated forward path of the audio and video data, a bandwidth allocating plan, and a traffic allocating plan, according to the difference.

S630, the core node 32 receiving the training data transmitted by the video server 33, and forwarding the training data according to the forward logic.

In detail, the core node 32 can be a multi-control unit (MCU) for processing the training data transmitted by the video server 33, the training data can be audio and video data, the MCU is used for accomplishing a routing, a forwarding, and a processing of the audio and video data. For example, after synchronous separating information flow of the training data, the MCU extracts information of audio, video, data, signaling, and so on, transmits the information to the information process module, and accomplishes a process of the information, such as audio mixing or switching, video information mixing or switching, data information broadcasting and routing, time setting, signaling controlling, and so on. At last, the processed audio, video, data, and signaling are re-combined together to be transmitted to each corresponding node.

In detail, the core node 32 receives the forward logic and selects a secondary node 34 according to the forward logic. For example, the secondary nodes 34 are set as region push nodes of different regions, when selecting a specific secondary node in the forward logic for transmitting the training data, the core node 32 pushes the training data to the specific secondary node.

S640, the secondary nodes 34 receiving the training data transmitted by the core node 32, and transmitting the training data to the trained terminal 35 according to the forward logic.

In detail, the secondary nodes 34 can be a MCU, when there are multiple trained regions, there are also multiple secondary nodes 34.

In detail, when there are multiple trained terminals distributed in different regions. The trained terminal 35 can be a mobile terminal (such as a smart phone), a personal computer, and also can include a classroom trained terminal.

S650, the control center 30 selecting a demonstration trained terminal, the secondary node 34 corresponding to the demonstration trained terminal transmitting a demonstration video to the core node 32.

In detail, the network training has a large range, a long distance, and more audience, thus it can not to achieve a face-to-face communication during the training. However, during a teaching or learning process, different problems will be encountered. When the trainee generates a question about the lesson of the training teacher, it can not to achieve a face-to-face inquiry and communication. Thus, it is necessary that the demonstration terminal is set in the network training.

In detail, one or more in the trained terminals 35 can be selected as the demonstration trained terminal.

In detail, in one embodiment, if one demonstration point is needed for demonstrating, the control center 30 can selects a training classroom, the video of the training classroom is forwarded to the MCU of the core node 32 trough MCU of the secondary nodes 34 corresponding to the training classroom.

S660, the core node 22 forwarding the training data after being fused and processed with the demonstration audio and video information to the trained terminal 35.

In detail, the core node 32 forwards the training data received from the video server 33 after being fused and processed with the demonstration audio and video information received from the demonstration training classroom to the trained terminal 35, the trained terminal 35 can directly watch a training teach and an interactive information in live after receiving the fused training data.

### Seventh Embodiment

It is understood by those person of an ordinary skill in the art that all or a part of the steps in the above embodiment is accomplished through the hardware related to the one or more program commands, the one or more programs are stored in a computer readable storage medium, when the one or more programs is executed, the following steps are implemented:

The control center 30 pushing the node control table.

The management gateway 31 generating a forward logic of the audio and video data and allocating the network bandwidth according to the node control table.

The core node 32 receiving the training data transmitted by the video server 33, and forwarding the training data according to the forward logic.

The secondary nodes 34 receiving the training data transmitted by the core node 32, and multicasting the training data to the trained terminal 35 according to the forward logic.

Further, it also can implement the step:

The control center 30 acquiring the training information, and generating the node control table according to the training information.

Further, it also can implement the step:

The secondary nodes 34 storing the training data after receiving the training data.

Further, it also can implement the step:

The control center 30 selecting a demonstration trained terminal, the secondary node 34 corresponding to the demonstration trained terminal transmitting the demonstration video of the demonstration trained terminal to the core node 32;

The core node 32 forwarding the training data being fused and processed with the demonstration video to the trained terminal 35.

The foregoing numbering of the embodiments of the disclosure is intended for description only, and is not indicative of the advantages and disadvantages of these embodiments.

It is to be noted that the term of “include” and “comprise”, or any other variant aim at covering non-excludable including, so that a process, device, object or method including a series of elements not only includes those elements, but also include other elements which are not listed clearly or further includes elements intrinsic to process, the device, the object or the method. In the absence of more restrictions, an element defined by a sentence “including a/an . . . ” does not exclude existence of the same other element in a process, device, object or method including the element.

By the description of the foregoing embodiments, it will be evident to those skilled in the art that the methods according to the above-mentioned embodiments can be implemented by means of software plus the necessary general-purpose hardware platform; and they can of course be implemented by hardware, but in many cases the former will be more advantageous. Based on such an understanding, the essential technical solution of the disclosure, or the portion that contributes to the prior art may be embodied as software products. Computer software products can be stored in a storage medium (e.g., a read-only memory (ROM)/random access memory (RAM), a magnetic disk, an optical disc), including multiple instructions that, when executed, can cause a computing device (e.g., a mobile phone, a computer, a server, a network device), to execute the methods described in the various embodiments of the disclosure.

The foregoing accompanying drawings describe exemplary embodiments of the disclosure, and therefore are not intended as limiting the patentable scope of the disclosure. The foregoing numbering of the embodiments of the disclosure is merely descriptive, it is not indicative of the advantages and disadvantages of these embodiments. In addition, although a logic sequence is shown in the flowchart, the steps shown or described may be executed in a sequence different from this logic sequence in some cases.

Those skilled in the art can make various transformation solutions to implement the disclosure without departing from the scope and essence of the disclosure, for example, features of one embodiment may be used in another embodiment to obtain another embodiment. Any modifications, equivalent replacements and improvements that are made taking advantage of the technical conception of the disclosure shall all fall within the patentable scope of the disclosure.

What is claimed is:

1. A training system server architecture comprising:
a control center, configured to push a node control table;
a management gateway, coupled to the control center, and configured to generate forward logic and allocate network bandwidth according to the node control table;
a core node, coupled to the management gateway, and configured to receive the forward logic and training data transmitted by a video server and forward the training data according to the forward logic; and
secondary nodes, coupled to the core node, and configured to receive the forward logic and the training data, transmit the training data according to the forward logic to a trained terminal.

2. The training system server architecture of claim 1, wherein the control center comprises a central controller and a database; the central controller calls data in the database to generate the node control table.

3. The training system server architecture of claim 2, wherein the node control table comprises a node data table and a bandwidth allocating table; the node data table is used for selecting a node for transmitting data, and the bandwidth allocating table is used for allocating the network bandwidth.

4. The training system server architecture of claim 2, wherein the core node and the secondary nodes are multi-control units, and are used for processing training data transmitted by the video server.

5. The training system server architecture of claim 4, wherein the training data comprises audio data and video data.

6. The training system server architecture of claim 1, wherein the secondary nodes further comprise a storage for storing training data; the storage is a non-volatile storage.

7. A video data transmission method used in a training system server architecture, the training system server architecture comprising a control center, a management gateway, a core node, secondary nodes, a video server, and trained terminals; the method comprising:
the control center pushing a node control table;
the management gateway generating a forward logic of audio and video data according to the node control table and allocating network bandwidth;
the core node receiving training data transmitted by a video server, and selecting a node for forwarding the training data according to the forward logic; and
the secondary nodes receiving the training data transmitted by the core node, and multicasting the training data to the trained terminal according to the forward logic.

8. The video data transmission method of claim 7, wherein the core node and the secondary nodes are multi-control units, and are used for processing training data transmitted by the video server.

9. The video data transmission method of claim 7, wherein the method further comprising the following step:
the control center acquiring training information, and generating the node control table according to the training information.

10. The video data transmission method of claim 9, wherein the training information comprises an amount and addresses of the trained terminals.

11. The video data transmission method of claim 9, wherein the control center comprises a central controller and a database; the central controller calls data in the database to generate the node control table.

12. The video data transmission method of claim 9, wherein the method further comprising the following step:
the secondary nodes storing the training data after receiving the training data.

13. The video data transmission method of claim 12, wherein the method further comprising the following step:
the control center selecting a demonstration trained terminal, the secondary node corresponding to the demonstration trained terminal transmitting a demonstration video to the core node; and
the core node forwarding the training data after being fused and processed with a demonstration video to the trained terminal.

14. A computer readable storage medium, the computer readable storage medium stores video data transmitting programs; the video data transmitting programs are used in a training system server architecture; the training system server architecture comprises a control center, a management gateway, a core node, secondary nodes, a video server, and trained terminals; the video data transmitting programs are executed by at least one processor for performing following steps:
the control center pushing a node control table;
the management gateway generating a forward logic of audio and video data and allocating network bandwidth according to the node control table;
the core node receiving training data transmitted by a video server, and selecting a node for forwarding the training data according to the forward logic; and
the secondary nodes receiving the training data transmitted by the core node, and multicasting the training data to the trained terminals according to the forward logic.

15. The computer readable storage medium of claim 14, wherein the core node and the secondary nodes are multi-control units, and are used for processing training data transmitted by the video server.

16. The computer readable storage medium of claim 14, wherein the at least one processor executes the following step:
the control center acquiring training information, and generating the node control table according to the training information.

17. The computer readable storage medium of claim 16, wherein the training information comprises an amount and addresses of the trained terminals.

18. The computer readable storage medium of claim 16, wherein the node control table comprises a node data table and a bandwidth allocating table; the node data table is used for selecting a node for transmitting data, and the bandwidth allocating table is used for allocating the network bandwidth.

19. The computer readable storage medium of claim 16, wherein the at least one processor executes the following step:
the secondary nodes storing the training data after receiving the training data.

20. The computer readable storage medium of claim 19, wherein the at least one processor executes the following steps:
the control center selecting a demonstration trained terminal, the secondary node corresponding to the demonstration trained terminal transmitting a demonstration video to the core node; and
the core node forwarding the training data after being fused and processed with a demonstration video to the trained terminal.
